(19) United States
(12) Patent Application Publication
(10) Pub. No.: US 2006/0164040 A1
(43) Pub. Date: Jul. 27, 2006

(54) Power source control method, electronic device and system using the same

(75) Inventor: Norio Ohkubo, Tokyo (JP)

Correspondence Address: MILES & STOCKBRIDGE PC, 1751 PINNACLE DRIVE, SUITE 500, MCLEAN, VA, 22102-3833, US

(73) Assignee: Hitachi, Ltd.

(21) Appl. No.: 11/072,256

(22) Filed: Mar. 7, 2005

(30) Foreign Application Priority Data
Jan. 21, 2005 (JP) 2005-013506

(51) Int. Cl. H02J 7/00

(52) U.S. Cl. 320/135

(57) ABSTRACT

A determining circuit determines whether power is supplied from a power generator or power is supplied from a battery, and an operation interval control circuit performs control of an intermittent operation in the sensor node based upon the determination result. For example, when power supplying from the battery continues for a predetermined time, a processing for extending the operation interval of the sensor node or a processing for putting the sensor node in a continuous standby state is performed, thereby reducing the wasteful power consumption of the battery. Then, when power supplying from the power generator is recovered, the sensor node is switched to an ordinary operation. Accordingly, an electronic equipment with a power generator and a battery as a power source in which the life of the battery is extended and the battery replacement is almost unnecessary is provided.

### CROSS-REFERENCE TO RELATED APPLICATION

The present application claims priority from Japanese Patent Application JP 2005-013506 filed on Jan. 21, 2005, the content of which is hereby incorporated by reference into this application.

### TECHNICAL FIELD OF THE INVENTION

The present invention relates to a control technique of a power source which operates electronic equipment with minute generated power. In particular, it relates to a technique effective for power source control of electronic equipment which performs the operation of a microcomputer, the radio communication or the like by using vibration power generation, a solar battery or the like.

### BACKGROUND OF THE INVENTION

As the method for the low power consumption for a sensor with a communication function provided with a power generating unit and a battery, for example, a technique that expands an operation interval of a sensor with a communication function to achieve the low power consumption when a remaining amount of power in a battery reduces has been known (see Japanese Patent Application Laid-Open No. 2003-281673).

### SUMMARY OF THE INVENTION

However, in the technique for the low power consumption in a sensor with a communication function, the inventor of the present invention has found that there are the following problems.

That is, when an operation interval is expanded to reduce a power consumption after the remaining amount (battery level) of power in the battery is reduced, since the operation interval is expanded after the remaining amount of power is reduced, there is such a problem that the reduction in power consumption cannot be achieved sufficiently.

Further, in the case where a sensor with a communication function is operated with using the power generation from immediate energy, the sensor operation may be stopped in many cases when the power generation becomes low. For example, it is unnecessary to operate a temperature sensor using a solar battery in a dark room, namely, in a place where any person is not present.

On the contrary, when the sensor is operated in such a time that it is unnecessary to operate the sensor, power is consumed wastefully, which results in the reduction in life of the battery. For example, in such a case that remote monitor is performed by using the power generation with vibrations of a motor to monitor a temperature of the motor, it is unnecessary to monitor the temperature when the motor stops and vibrations disappear.

In view of these circumstances, an object of the present invention is to provide a system that achieves low power consumption in a sensor with a communication function to increase the life of a battery.

Another object of the present invention is to provide a power source control method capable of starting the low power consumption operation before the remaining amount of power in a battery becomes low and achieving the high reduction effect of power consumption, an electronic device, and a system using the same.

The above and other objects and novel characteristics of the present invention will be apparent from the description and the accompanying drawings of this specification.

The typical ones of the inventions disclosed in this application will be briefly described as follows.

The present invention provides a power source control method in which a power generator and a battery are provided as a power source for electronic equipment which can be switched between a standby state and an active state, power supplying from the power generator is used when power can be supplied from the power generator, and power is supplied from the battery when power cannot be supplied from the power generator, and the method comprises the steps of: determining whether power is being supplied from the power generator or power is being supplied from the battery; setting an operation mode of the electronic equipment to a standby state when power supplying from the battery continues for a predetermined time; and returning the electronic equipment to an ordinary operation when power supplying from the power generator is enabled.

Also, the present invention provides a power source control method in which a power generator and a battery are provided as a power source for electronic equipment which can be switched between a standby state and an active state, power supplying from the power generator is used when power can be supplied from the power generator, and power is supplied from the battery when power cannot be supplied from the power generator, and the method comprises the steps of: determining whether power is being supplied from the power generator or power is being supplied from the battery; extending an interval of an intermittent operation in an operation mode of the electronic equipment arbitrarily when power supplying from the battery continues for a predetermined time; and returning the electronic equipment to an ordinary operation when power supplying from the power generator is enabled.

Also, the outlines of the other inventions will be briefly described below.

The present invention provides an electronic device provided with a power generator and a battery as a power source for electronic equipment which can be switched between a standby state and an active state, in which power supplying from the generator is used when power can be supplied from the power generator, and power is supplied from the battery when power cannot be supplied from the power generator, and the device comprises: a power source determining unit which determines whether power is being supplied from the power generator or power is being supplied from the battery; and an operation interval control unit which sets an operation mode of the electronic equipment to the standby state for an arbitrary period when power supplying from the battery continues for a predetermined time and returns the electronic equipment to an ordinary operation when power supplying from the power generator is enabled.

Also, a sensor network system according to the present invention comprises: a sensor unit having a radio communication function which can switch a standby state and an active state; and a power source control unit for supplying power to the sensor unit, wherein the power source control unit comprises: at least one electronic device provided with a power generator, a battery, a power source determining unit for determining whether power is supplied from a power generator or power is supplied from a battery, and an operation interval control unit which sets an operation mode of the electronic equipment to the standby state for an arbitrary period when power supplying from the battery continues for a predetermined time and returns the electronic equipment to an ordinary operation when power supplying from the power generator is enabled; at least one base station receiving a radio signal outputted from the sensor unit; and a server for processing the signal received by the base station via a wireless or wired network.

The effect obtained by the representative one of the inventions disclosed in this application will be briefly described as follows.

(1) It becomes possible to significantly increase the life of a battery for backup used in electronic equipment.

(2) Since electronic equipment can autonomously control a power source, load on a server and a network can be reduced and power consumption in the electronic equipment can be reduced.

(3) According to (1) and (2), by constituting a sensor network system using the electronic equipment equipped with a power source control unit, a system with a high reliability can be established without considering the power source.

### BRIEF DESCRIPTIONS OF THE DRAWINGS

FIG. 1 is a block diagram showing the configuration of a sensor node according to an embodiment of the present invention;

FIG. 2 is a block diagram showing another configuration example of the sensor node shown in FIG. 1;

FIG. 3 is a flowchart showing one example of a control operation in a sensor node according to an embodiment of the present invention;

FIG. 4 is an explanatory diagram showing one example of the control operation in the sensor node according to an embodiment of the present invention;

FIG. 5 is a block diagram showing a configuration example of a part of a power control unit provided in a sensor node according to an embodiment of the present invention;

FIG. 6 is a block diagram showing an example of a part of a power source control unit provided in a sensor node according to an embodiment of the present invention;

FIG. 7 is a block diagram showing another example of a power source control unit provided in a sensor node according to an embodiment of the present invention;

FIG. 8 is an explanatory diagram showing a mounting example in a sensor node according to an embodiment of the present invention;

FIG. 9 is a configuration diagram showing one example of a sensor network system configured using the sensor nodes according to an embodiment of the present invention; and

FIG. 10 is an appearance view showing one example of a sensor node according to an embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

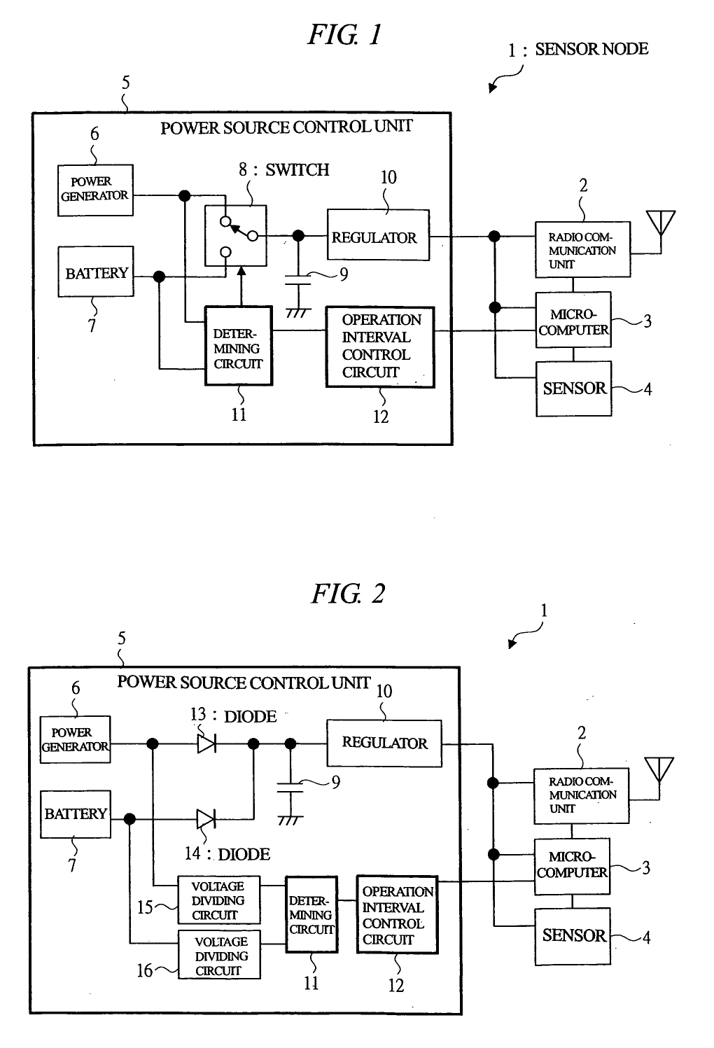

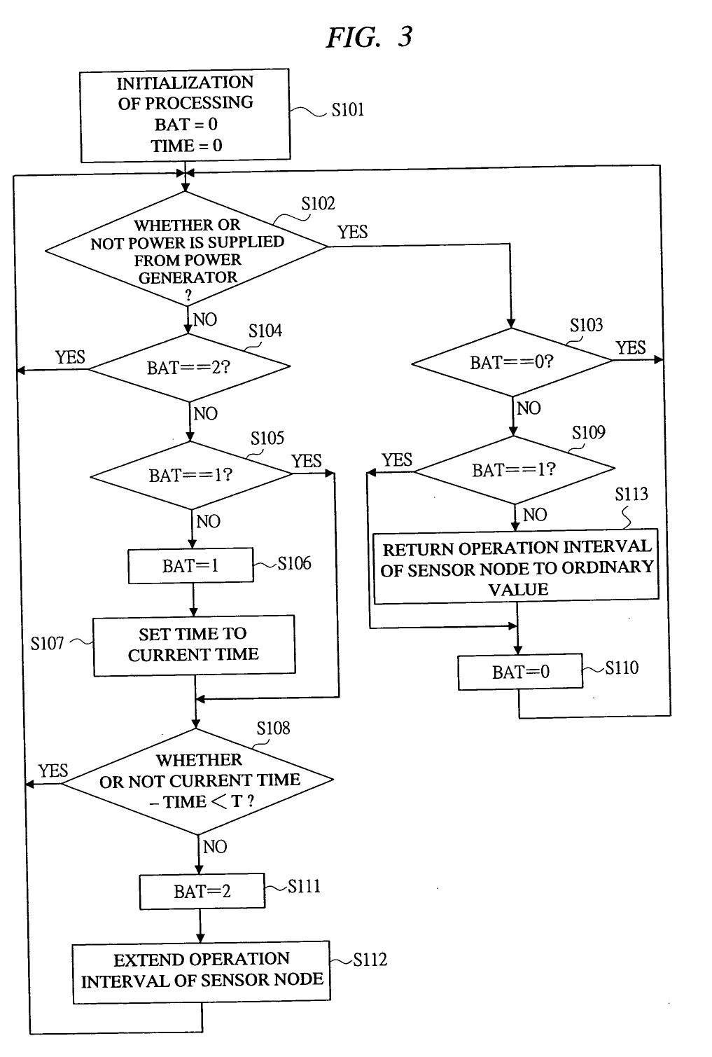

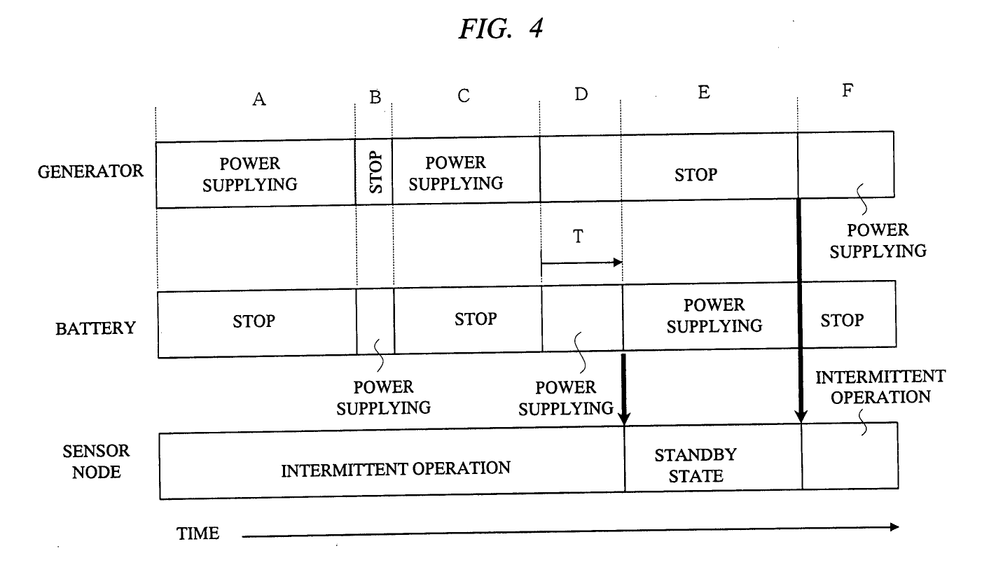

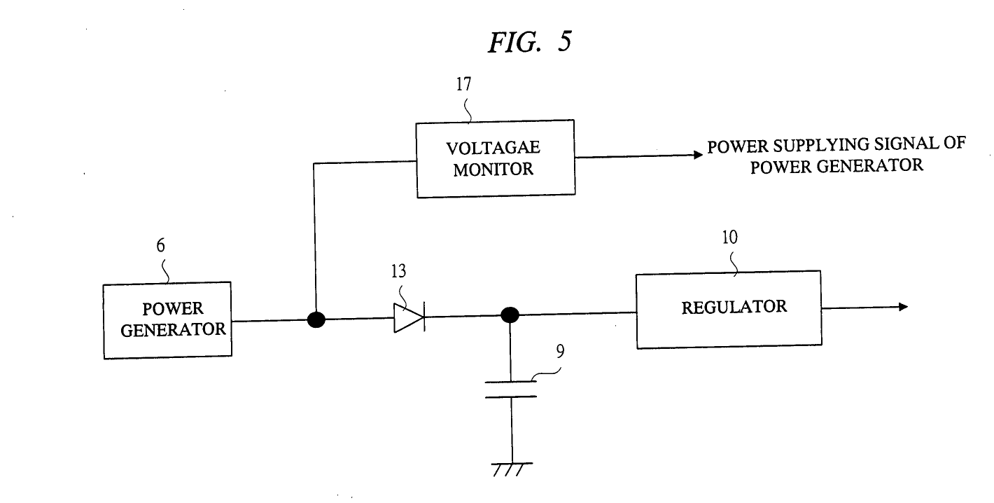

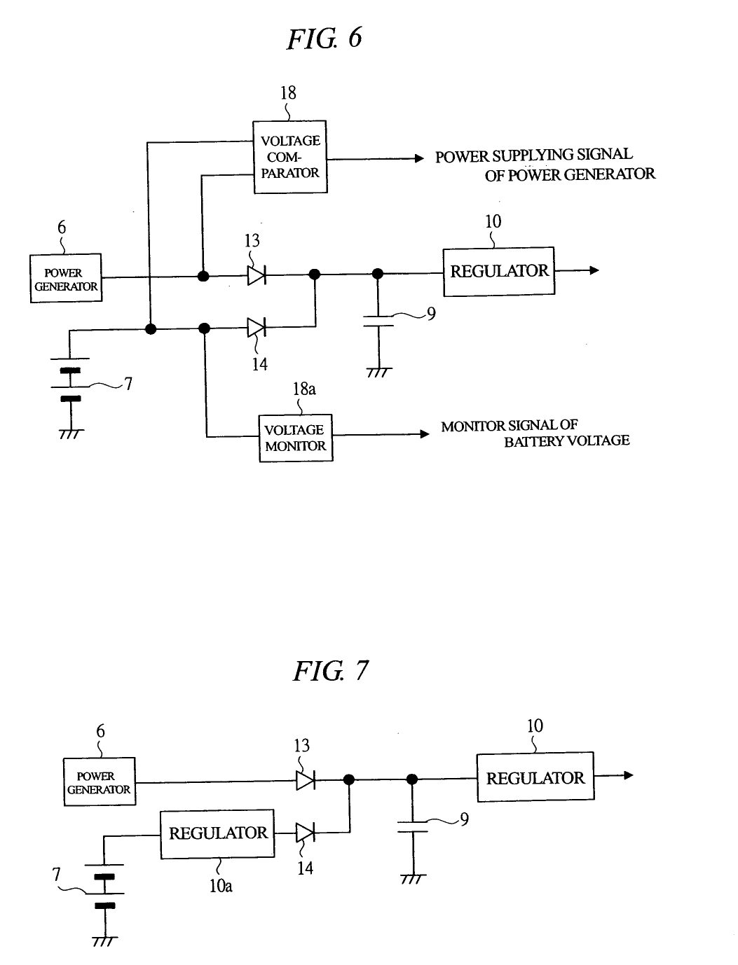

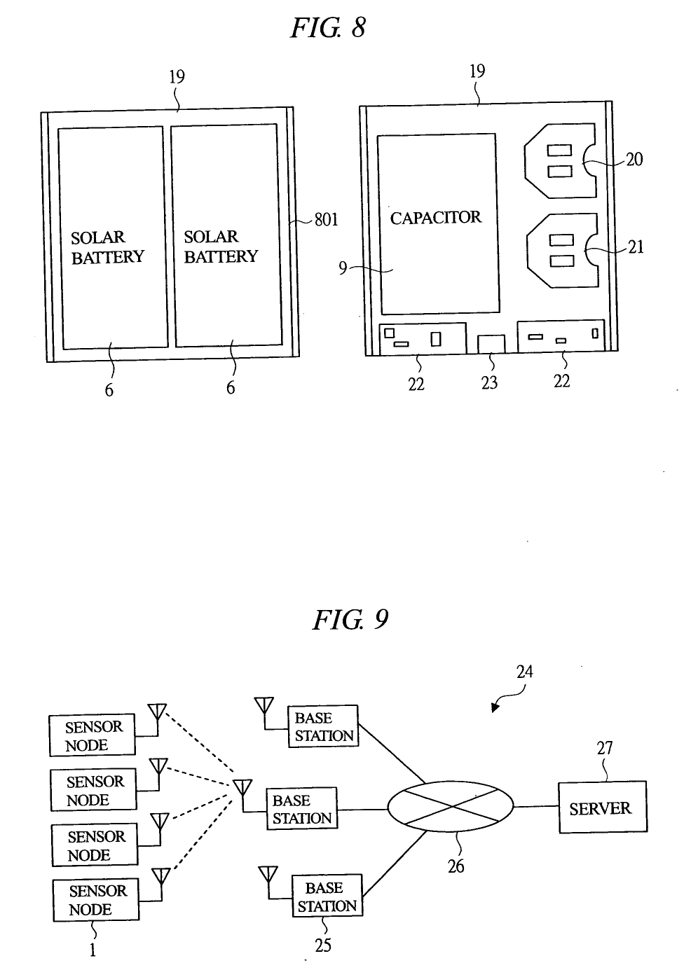

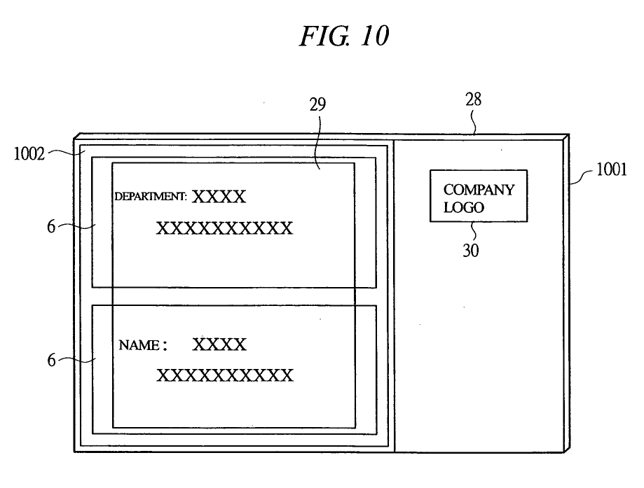

FIG. 1 is a block diagram showing the configuration of a sensor node according to an embodiment of the present invention; FIG. 2 is a block diagram showing another configuration example of the sensor node shown in FIG. 1; FIG. 3 is a flowchart showing one example of a control operation in a sensor node according to an embodiment of the present invention; FIG. 4 is an explanatory diagram showing one example of the control operation in the sensor node according to an embodiment of the present invention; FIG. 5 is a block diagram showing a configuration example of a part of a power control unit provided in a sensor node according to an embodiment of the present invention; FIG. 6 is a block diagram showing an example of a part of a power source control unit provided in a sensor node according to an embodiment of the present invention; FIG. 7 is a block diagram showing another example of a power source control unit provided in a sensor node according to an embodiment of the present invention; FIG. 8 is an explanatory diagram showing a mounting example in a sensor node according to an embodiment of the present invention; FIG. 9 is a configuration diagram showing one example of a sensor network system configured using the sensor nodes according to an embodiment of the present invention; and FIG. 10 is an appearance view showing one example of a sensor node according to an embodiment of the present invention.

In this embodiment, a sensor node (an electronic device) 1 that is a small-sized sensor having a communication function is comprised of a radio communication unit 2 (a sensor unit), a microcomputer (hereinafter, “MC”) 3, a sensor (a sensor unit) 4, and a power source control unit 5 as shown in FIG. 1.

The radio communication unit 2 performs radio communication with a base station which performs the radio communication with the sensor node 1. The MC 3 serves to control the sensor node 1. The sensor 4 is comprised of sensors such as a temperature sensor, a vibration sensor and the like.

Also, the power source control unit 5 is comprised of a power generator 6, a battery 7, a switch 8, a capacitor 9, a regulator 10, a determining circuit (a power source determining unit) 11, and an operation interval control circuit (operation interval control unit) 12. For example, the power generator 6 is comprised of a solar battery for generating power. The battery 7 is a primary battery.

The switch 8 is a switch for performing switching between the power supplying from the power generator 6 and the power supplying from the battery 7, and it can be realized using a MOS (Metal Oxide Semiconductor) transistor, for example.

The capacitor 9 stores the power supplied to the regulator 10 via the switch 8 and it performs power supplementation when the voltage drops. The regulator 10 function to stabilize the voltage and supply power source voltage to the radio communication unit 2, the MC 3, the sensor 4, and the like.

The determining circuit 11 performs the determination whether the power is supplied from the power generator 6 or from the battery 7. The operation interval control circuit 12 performs the control of an intermittent operation in the sensor node 1.

As the power source for the sensor node 1, commercially available power source cannot be utilized because a cost for leading a wire should be cut down, the portability is lost, and so on. When a battery is utilized, it becomes necessary to conduct maintenance and management for battery exchange, which is not so desirable. Therefore there is a strong demand to convert immediate energy to electric energy to utilize the same, if possible.

Therefore, it is considered to utilize power generated by utilizing light, vibration, temperature difference, or the like as immediate energy. However, these immediate energies cannot produce the sufficient power for always operating a radio communication device or an MC.

Therefore, it is necessary to cause the sensor 4, the MC 3, and the radio communication unit 2 to intermittently operate at constant intervals or at variable intervals to achieve low power consumption. For example, low power consumption of 1/3000 can be realized when intermittent operation for 100 ms is conducted for each five minutes.

The operation interval control circuit 12 is provided for controlling the intermittent operation. A signal is transmitted from the operation interval control circuit 12 to the MC 3 so that the MC 3 controls an active state or a standby state. The radio communication unit 2 and the sensor 4 perform the power control from the MC.

When the power generator 6 is used as a power source for the sensor node 1, since the power generation is unstable, the backup from the battery 7 is required. For example, when a solar battery is used as the power generator 6, an event of that the power generation is hindered may occur when solar light is blocked by a person standing in front of the solar battery.

Therefore, when the power generator 6 cannot supply the power, the power supplying is switched to that from the battery 7. Such a control is made by the determining circuit 11. The determining circuit 11 compares a voltage of the power generator 6 and a voltage of the battery 7 with each other and performs the switching to the power generator 6 when the voltage of the power generator 6 is higher than that from the battery 7. Alternatively, determination can be made based upon only the voltage of the power generator 6. Also, it is necessary to confirm a voltage in the battery to monitor the battery level of the battery.

The most significant problem about the backup by the battery 7 lies in that battery operation increases in an unnecessary period. For example, when a sensor node for monitoring a room temperature is operated by a solar battery, it is unnecessary to always acquire a temperature in a dark room where any person is not present.

However, since the solar battery does not generate power in a dark room, the sensor node is operated by the battery 7. Alternatively, also in a case that a temperature monitor is remotely monitored as motor maintenance with using the vibrations of a motor, when the motor stops, the power generation due to the vibrations also stops. Therefore, the switching to an operation using the battery takes place. However, since the motor is actually in its stopped state, it is unnecessary to monitor a temperature of the motor.

In the present invention, it is possible to suppress the wasteful consumption of the battery by performing the process for increasing an operation interval of the sensor node 1 or setting the sensor node 1 to a standby state when power supplying from the battery 7 continues for a predetermined time.

For example, in such a configuration that the sensor node 1 is set to a standby state when the power supplying from the battery 7 continues for one hour, the life of the battery is extended nine times if the power saving for eight hours in night can be achieved. Since the battery 7 is originally used for backup, it is desirable that the life of the battery is longer than that of the equipment. Therefore, even if the battery life is conventionally one or two years, a battery life of 10 years or more can be achieved according to the present invention.

FIG. 2 is a block diagram showing another configuration example in the sensor node 1.

In this case, the sensor node 1 is comprised of a radio communication unit 2, an MC 3, a sensor 4, and a power source control unit 5 like the configuration shown in FIG. 1.

The power source control unit 5 is comprised of a power generator 6, a battery 7, a capacitor 9, a regulator 10, a determining circuit 11, an operation interval control circuit 12, diodes 13 and 14, and voltage dividing circuits 15 and 16.

The diode (a first diode, a second diode) 13 is connected between the power generator 6 and an input of the regulator 10, and the diode (a third diode) 14 is connected between the battery 7 and the input of the regulator 10. In this configuration, the power is supplied from either of the power generator 6 or the battery 7 with higher voltage by using the diodes 13 and 14.

The voltage dividing circuits 15 and 16 are connected between the power generator 6 and the determining circuit 11 and between the battery 7 and the determining circuit 11, respectively, and they must be inserted therebetween when the voltage of the power generator or the battery exceeds an allowable input voltage of the determining circuit 11.

Also in FIG. 2, it is possible to suppress the wasteful consumption of the battery 7 by performing a processing for increasing an operation interval of the sensor node 1 or setting the sensor node 1 to a standby state when power supplying from the battery 7 continues for a predetermined time.

For example, in such a configuration that the sensor node 1 is set to a standby state when the power supplying from the battery 7 continues for one hour, the life of the battery is extended nine times if the power saving for eight hours in night can be achieved. Since the battery 7 is originally used for backup, it is desirable that the life of the battery is longer than that of the equipment. Therefore, even if the battery life is conventionally one or two years, a battery life of 10 years or more can be achieved according to the present invention.

FIG. 3 is a flowchart showing one example of a control operation of the sensor node 1 according to the embodiment.

When the sensor node 1 is first supplied with power or it is reset, a variable BAT and a variable TIME are initialized to 0 (Step S101).

Here, the following patterns will be described.

(1) Case that Power is being Supplied from the Power Generator 6

After the variable BAT and the variable TIME are initialized to 0, it is determined whether or not power is being supplied from the power generator 6 (Step S102). Here, since the power is being supplied from the power generator 6, it is determined whether or not the variable BAT is 0 (Step S103). Also in this case, since the power is being supplied by the power generator 6, power supplying is not performed from the battery 7. Therefore, the variable BAT is 0 and the control returns back to the processing in Step S102.

(2) Case that the Power Generator 6 Temporarily Stops, but Power Generation from the Power Generator 6 is Recovered in a Time Shorter than a Predetermined Time T

After the variable BAT and the variable TIME are initialized to 0, it is determined whether or not the power is being supplied from the power generator 6 (Step S102). Here, since the power is not being supplied from the power generator 6, it is determined whether or not the variable BAT is 2 (Step S104). In the processing in Step S103, the variable BAT is 0 (the state that power is not being supplied from the battery 7).

Subsequently, it is determined whether or not the variable BAT is 1 (Step S105).

In the processing in Step S105, since the variable BAT is 0, 1 is substituted for the variable BAT (Step S106) and a current time is substituted for the variable TIME (Step S107).

Thereafter, it is determined whether or not the time elapsing from stopping of the power generator 6 is shorter than a predetermined time T (Step S108). Here, since this time is shorter than the predetermined time T, the control returns back to the processing in Step S102.

When the power supplying from the power generator 6 is recovered while the time elapsing from the stop of the power generator 6 is shorter than the predetermined time T, after the processings in Steps S102 and S103 are performed, it is determined whether or not the variable BAT is 1 (Step S109).

Here, since 1 is substituted for the variable BAT in the processing in Step S106, a processing for returning the variable BAT back to 0 which is an initial value is performed (Step S110), and the control returns back to the processing in Step S102.

(3) Case that a Time of the Stop of the Power Generator 6 is Longer than the Predetermined Time T and Power Generation Performed by the Power Generator 6 is Recovered thereafter.

This case is the same as the above pattern (2) until 1 is substituted for the variable BAT (the processing in Step S106). In the processing in Step S108, however, when a time elapsing from the stop of the power generator 6 is longer than the predetermined time T, 2 is substituted for the variable BAT (Step S111) and an operation interval of the sensor node 1 is expanded (Step S112).

Thereafter, when power supplying from the power generator 6 restarts, after performing the processings in Steps S102, S103, and S109, the operation interval of the sensor node 1 is returned back to the ordinary value (Step S113), and the variable BAT is returned back to 0 which is the initial value by the processing in Step S110.

According to the above procedure, the life of the battery 7 for backup can be extended.

FIG. 4 is an explanatory diagram showing one example of the control operation of the sensor node 1.

As shown in FIG. 4, a state A indicates a state where power is being supplied by the power generator 6. A state B indicates that power generation temporarily stops and power is being supplied by the battery 7. For example, the power supplying often stops when a person stands up in front of the solar battery if a solar battery is used as the power generator 6 or when vibration of a motor in an elevator is used for the power generation.

A state C indicates that the power generation returns back to the power generation conducted by the power generator 6. A state D indicates that the power generator 6 stops and power is being supplied by the battery 7, and when the predetermined time T elapses, the state D transfers to a state E that the sensor node 1 becomes the standby state, in which an operation mode of the sensor node 1 becomes a low power consumption mode.

This mode is a state that the power generator 6 stops for a while. When the power generator 6 restarts, the sensor node 1 returns back to an active state and the state transfers to a state F that power is supplied by the power generation. This is realized by such a processing as the interruption in the sensor node 1 during the standby state.

In this case, the determining circuit 11 is provided on a chip different from that of the MC 3. By doing so, the sensor node 1 can return back from the standby state, namely, the MC 3 can return back from the standby state by performing the interruption from the determining circuit 11 to the MC 3.

It is also possible to form the determining circuit 11 on the same chip as that of the MC 3. In that case, however, although it is possible to increase an operation interval of the sensor node 1, the sensor node 1 cannot be set to the standby state because the MC 3 cannot be returned from the standby state.

FIG. 5 is a block diagram showing a configuration example of a part in the power source control unit 5. In FIG. 5, a circuit for determining whether power is being supplied by the power generator 6 is mainly shown.

In this case, an anode of the diode 13 and a voltage monitor (a power source determining unit) 17 serving as the determining circuit 11 are respectively connected to the power generator 6, and one of connection portions of the capacitor 9 and an input of the regulator 10 are connected to a cathode of the diode 13. A reference potential (VSS) is connected to the other connection portion of the capacitor 9.

Here, in order to store minute generated power to perform intermittent operation, the capacitor 9 is required to have a capacitance of, for example, about 1 mF or more, and a electric double layer capacitor is used as the capacitor 9. The diode 13 is provided so as to prevent the counter flow of the current when the voltage generated by the power generator 6 is lower than the voltage of the capacitor 9.

The voltage monitor 17 outputs a power supplying signal to the MC 3 or the like while power supplying is being performed by the power generator 6. A connecting position of the voltage monitor 17 must be set at a connecting point of the power generator 6 and the diode 13. This is because, when a voltage is measured at the position above the diode 13, a high voltage is measured due to the large capacitance of the capacitor 9 even when the power generator 6 is in a non-active state.

FIG. 6 is a block diagram showing another example of a circuit for determining whether or not power supplying is being conducted by the power generator 6 in the power source control unit 5.

In this case, the power generator 6 is connected to the anode of the diode 13 and one of inputs of a voltage comparator (a power source determining unit) 18 serving as the determining circuit 11, and the battery 7 is connected to the anode of the diode 14, the other input of the voltage comparator 18, and a voltage monitor 18a.

One connection portion of the capacitor 9 and an input of the regulator 10 are connected to the cathodes of the diode 13 and 14. Also, a reference potential (VSS) is connected to the other connection portion of the capacitor 9.

The voltage comparator 18 compares voltage values of the power generator 6 and the battery 7 with each other and outputs a signal indicating power supplying from the power generator 6 to the MC 3. The voltage monitor 18a monitors the voltage of the battery 7 and outputs the result obtained by the monitoring to the MC 3 as a monitor signal.

Also in this case, in order to store minute generated power to perform the intermittent operation, the capacitor 9 is also required to have a capacitance of, for example, about 1 mF or more, and a electric double layer capacitor is used as the capacitor 9.

The diodes 13 and 14 are required to prevent the counter flow of the current when the voltage of the power generator 6 or the voltage of the battery 7 is lower than the voltage of the capacitor 9, and can automatically switch the voltage or the power generator 6 and that of the battery 7 by setting the voltage generated when the power generator 6 operates to be higher than a voltage of the battery 7.

Here, a connecting position of the voltage comparator 18 must be at a connecting point between the power generator 6 and the diode 13 and a connecting point between the battery 7 and the diode 14. This is because, when a voltage is measured at the position above the diodes 13 and 14, a high voltage is measured due to the large capacitance of the capacitor 9.

The voltage monitor 18a can confirm whether or not the remaining battery level of the battery 7 is being reduced, output a monitor signal to the MC 3 when the remaining battery level is reduced, and notify a timing for replacement of the battery 7 to a user in advance.

FIG. 7 is a block diagram showing one example of the power source control unit 5 employing such configuration that a voltage outputted from the power generator 6 becomes higher than a voltage of the battery 7.

In this case, the power generator 6 is connected to the anode of the diode 13, and the battery 7 is connected to an input connection portion of a regulator (a voltage dropping unit) 10a which drops the voltage of the battery 7. The anode of the diode 14 is connected to an output of the regulator 10a.

One of connection portions of the capacitor 9 and an input of the regulator 10 are connected to the cathodes of the diodes 13 and 14, respectively. Also, the reference voltage (VSS) is connected to the other connection portion of the capacitor 9.

By setting the voltage of the battery 7 by the regulator 10a and the voltage of the generator 6 to be higher than the output voltage of the regulator 10a when the power generator 6 operates as described above, the power supplying between that from the power generator 6 and that from the battery 7 can be automatically switched. Incidentally, any configuration which can reduce the voltage can be employed as the regulator 10a, and the regulator 10a may be comprised of diodes connected in series.

FIG. 8 is an explanatory diagram showing a mounting example in the sensor node 1.

As shown on the left side in FIG. 8, two solar batteries as a power generator 6 are mounted on a surface of a circuit board 19. As shown on the right side in FIG. 8, on a rear surface of the circuit board 19, a capacitor 9 is mounted on the left side of the circuit board 19, and battery holders 20 and 21 for a button-shaped battery in which a battery 7 is placed are mounted from an upper portion to a lower portion of the circuit board on the right side thereof.

Electronic part mounting portions 22 in which electronic parts such as a capacitor and a resistor are mounted are provided below the capacitor 9 and the battery holders 20 and 21 for a button-shaped battery, and a power source connector 23 is provided at a central portion between the electronic part mounting portions 22.

By mounting the power generator 6 comprised of the solar batteries on the surface of the circuit board 19 and mounting the capacitor 9 having a large area and the battery holders 20 and 21 for a button-shaped battery on the rear surface of the circuit board 19 in this manner, an area of the solar batteries can be made large and the generation power can be increased.

In FIG. 8, the radio communication unit 2, the MC 3, the sensor 4, and a part of circuits of the power source control unit 5 are not shown. However, they can be mounted on the circuit board 19 or can be mounted on another circuit board different from the circuit board 19.

FIG. 9 is a configuration diagram showing one example of a sensor network system 24 configured by using the sensor nodes 1 according to the present embodiment.

As shown in FIG. 9, the sensor network system 24 is comprised of the sensor nodes 1, base stations 25, a network 26, a sever 27, and the like. The base station 25 is a base station which performs radio communication with the sensor nodes 1 and is connected to a wired network 26.

With such a configuration, the sensor node 1 can perform the control on the power source in an autonomic manner without the participation of the server 27, and the low power consumption of the sensor node 1 can be achieved without increasing a load on the server 27 and the network 26.

The immediate energy can be utilized for the operation of the power source of the sensor node 1 and the battery replacement is almost unnecessary. Therefore, the sensor node without considering the power source can be realized.

FIG. 10 is an appearance view showing one example of the sensor node 1.

As illustrated in FIG. 10, the sensor node 1 is housed in a transparent plastic case (a transparent case) 28. The plastic case 28 is also used as a nameplate. The circuit board 19 (FIG. 8) is housed in the plastic case 28, and the solar batteries serving as the power generator 6 are positioned on a surface of the plastic case.

A transparent film 29 on which “department”, “name” and the like are written with white characters is attached on upper faces of the solar batteries. In FIG. 10, for example, a space 30 in which a company logo is written is provided on the right side of the plastic case 28, but this space is not always necessary.

The sensor node 1 can be made wearable by attaching a clip or a string on a rear surface of the plastic case 28 constituting the nameplate.

The sensor node 1 shown in FIG. 10 includes the nameplate as a typical wearing device, and it can be applied, for example, as a monitor for detecting a location of a user.

Since many solar batteries have a color in a range of dark purple to near black, characters written with white color can be made apparent even on the solar batteries by inserting a transparent film 29 with the characters. Therefore, the upper face of the solar battery can be utilized effectively, and an amount of power generation can be increased by expanding an area on which light is incident.

In the embodiment, the nameplate is used as the wearable gear, but this invention can be applied to other devices, of course.

The color of the character written on the transparent film 29 may be a color other than white, and it may be a color which facilitates the discrimination of the characters in consideration of the surface color of the solar battery.

In the foregoing, the invention made by the inventor of the present invention has been concretely described based on the embodiments. However, it is needless to say that the present invention is not limited to the foregoing embodiments and various modifications and alterations can be made within the scope of the present invention.

The present invention is suitable for a power source control technique of an electric device that performs an operation of a microcomputer and radio communication by using the vibration power generation, a solar battery or the like.

What is claimed is:

1. A power source control method in which a power generator and a battery are provided as a power source for electronic equipment which can be switched between a standby state and an active state, power supplying from said power generator is used when power can be supplied from said power generator, and power is supplied from said battery when power cannot be supplied from said power generator, said method comprising the steps of:
determining whether power is being supplied from said power generator or power is being supplied from said battery;
setting an operation mode of said electronic equipment to a standby state when power supplying from said battery continues for a predetermined time; and
returning said electronic equipment to an ordinary operation when power supplying from said power generator is enabled.

2. A power source control method in which a power generator and a battery are provided as a power source for electronic equipment which can be switched between a standby state and an active state, power supplying from said power generator is used when power can be supplied from said power generator, and power is supplied from said battery when power cannot be supplied from said power generator, said method comprising the steps of:
determining whether power is being supplied from said power generator or power is being supplied from said battery;
extending an interval of an intermittent operation in an operation mode of said electronic equipment arbitrarily when power supplying from said battery continues for a predetermined time; and
returning said electronic equipment to an ordinary operation when power supplying from said power generator is enabled.

3. An electronic device provided with a power generator and a battery as a power source for electronic equipment which can be switched between a standby state and an active state, in which power supplying from said generator is used when power can be supplied from said power generator, and power is supplied from said battery when power cannot be supplied from said power generator, said device comprising: a power source control unit, which includes:
a power source determining unit which determines whether power is being supplied from said power generator or power is being supplied from said battery; and
an operation interval control unit which sets an operation mode of said electronic equipment to said standby state for an arbitrary period when power supplying from said battery continues for a predetermined time and returns said electronic equipment to an ordinary operation when power supplying from said power generator is enabled.

4. The electronic device according to claim 3,
wherein said power generator is at least either one of a solar battery, a power generator which generates power by vibrations, a power generator which generates power by a temperature difference, and a power generator which generates power by movement of an object.

5. The electronic device according to claim 3,
wherein said power source determining unit monitors a voltage outputted from said power generator and determines whether power supplying is from said power generator or power supplying is from said battery.

6. The electronic device according to claim 3, further comprising:
a first diode whose anode is connected to a voltage supplying unit in said power generator,
wherein said power source determining unit monitors a voltage of said power generator at a connecting node of said voltage supplying unit of said power generator and the anode of said first diode.

7. The electronic device according to claim 3,
wherein said power source determining unit compares a voltage outputted from said power generator and a voltage outputted from said battery with each other to determine whether power is supplied from said power generator or power is supplied from said battery.

8. The electronic device according to claim 3, further comprising:
a voltage drop unit which is connected to a voltage supplying unit of said battery to drop a voltage of said battery;
a second diode whose anode is connected to said voltage drop unit; and
a third diode whose anode is connected to a voltage supplying unit of said power generator,
wherein said voltage drop unit drops the voltage so that the voltage of said power generator becomes lower than an output voltage of said battery when the power generator is operated.

9. The electronic device according to claim 3,
wherein said electronic equipment is a sensor unit having a radio communication function, and said sensor unit is supplied with power from said power generator or said battery.

10. The electronic device according to claim 9,
wherein said power generator comprises a solar battery,
said electronic device is provided with a transparent case in which said sensor unit and said solar battery are housed, and
said transparent case has a shape of nameplate in which said solar battery is housed so that a surface thereof is positioned on said transparent case.

11. The electronic device according to claim 10,
wherein a character is printed with white or color which allows identification of the character on a surface of said transparent case on which the surface of said solar battery is positioned.

12. The electronic device according to claim 10, further comprising:
a transparent film on which a character is printed with white or color which allows identification of the character and which is inserted between said transparent case and the surface of said solar battery.
